(19) United States
(12) Patent Application Publication
(10) Pub. No.: US 2024/0084591 A1
(43) Pub. Date: Mar. 14, 2024

(54) ROOFING SYSTEMS, ROOFING SYSTEMS WITH INTEGRATED SOLAR RACKING SYSTEMS, ROOFING SYSTEM COMPONENTS, AND RELATED METHODS

(71) Applicant: Infinity Rack LLC, Morrisville, NC (US)

(72) Inventor: Christopher L Verner, Charlotte, NC (US)

(21) Appl. No.: 18/263,664

(22) PCT Filed: Feb. 17, 2022
(86) PCT No.: PCT/US2022/016881

§ 371 Date: Jul. 31, 2023

Related U.S. Application Data
(60) Provisional application No. 63/150,569, filed on Feb. 17, 2021.

(51) Int. Cl. E04B 7/04; H02S 20/24

(52) U.S. Cl. CPC E04B 7/04; H02S 20/24

(57) ABSTRACT

Roofing systems, roofing systems with integrated solar racking systems, roofing systems components, and related methods are provided herein. A roofing system can include two or more structural beams. Each of the two or more structural beams can include an extruded aluminum structural beam. The roofing system can also include roofing panels that can include at least one of an insulated roofing panel or a solar module. The roofing system can also include two or more top caps corresponding to the number of the two or more structural beams. The two or more top caps can be configured to secure the roofing panels in place on the two or more structural beams. Further, the roofing system can include gaskets for sealing the roofing panels and end fins attachable to at least one of the two or more structural beams or the two or more top caps to enclose end edges of the roofing system. Additionally, the roofing system can include one or more interior gutters built into each of the two or more structural beams to drain any water that leaks between the gaskets and the roofing panels.

### RELATED APPLICATIONS

The present patent application claims the benefit of PCT International Patent Application Serial. No. PCT/US2022/016881, filed Feb. 17, 2022, and U.S. Provisional Patent Application Ser. No. 63/150,569, filed Feb. 17, 2021, to which PCT International Patent Application Serial. No. PCT/US2022/016881 claims priority and benefit. The disclosures of both patent applications referenced above are incorporated herein by reference in their entireties.

### TECHNICAL FIELD

The present subject matter relates to roofing systems, roofing systems with integrated solar racking systems, roofing systems components, and related methods. In particular, the present subject matter relates to roofing systems that can provide for integration of solar panels or use of insulated roofing panels for non-solar applications to form a roofing system for a building or other structure.

### BACKGROUND

There has been an increasing demand of utilizing solar energy as a clean alternative for individual homes. Solar modules are of particular interest and are widely utilized and installed in a solar rack that resides on top of the existing roof of a house or other building. Generally, each of the solar modules can be arranged in an array and held between vertical rails in a racking system secured onto an existing roof. These solar racking system installations are typically not watertight as racks are affixed upon an existing roof. In these racking systems, rainwater leakage can become a problem. The rainwater seeps down through joints between the frame of the solar module and the vertical rail of the racking system and onto the roof. Such leakage as well as other issues encountered when mounting the racking system on the roof make such racking system installations less desirable, even when weighed against the benefits of solar power.

While there are existing racking structures that offer “watertight” solutions, they are less durable, more expensive to produce and construct, and much more complicated to install and assemble. For example, certain leading alternatives rely on wooden rafters or girders which can lead to rot and degradation of the structural integrity of the roof below the racking system. Racking systems are complicated and contain a multitude of parts which makes assembly complicated and makes user error more likely during installation. Existing watertight solutions rely on exposed commercial/roofing seam tape or ethylene propylene diene monomer rubber (EPDM) gaskets that are exposed to the sun and other elements which results in degradation over time and a typical maximum lifespan of around three (3) years before replacement is needed. Racking structures that do not rely on the seam tape or EPDM gaskets to create a watertight seal have purlin caps that protrude from between the solar panels or insulated metal plates that create water dams which cause water to pool leading to mold and waste buildups that can degrade and break the watertight seal over time and obstruct the energy collection of the solar panels.

To combat such issues that arise with solar module array installations that are secured to existing roofs, the construction industry stands to gain by integrating solar modules into roof assemblies in new construction or when replacing a roof on an existing structure. For such solar roof assembly installation, though, there are few options available for a fully integrated roofing system that include the structural member required and there are no options that offer reliable, lasting, watertight protection.

As such, in general construction and solar installation, a need exists to create an easy to assemble, long lasting, watertight roof assembly that reduces the number of steps required, reduces labor costs, and simplifies the process of both general roof construction as well as solar integration within a roof that can be used on structures of all types.

### SUMMARY

The present subject matter provides roofing systems, roofing systems with integrated solar racking systems, roofing systems components, and related methods. In particular, the present subject matter relates to roofing systems that support the integration of solar panels into the roofing structure and/or support the use of insulated roofing panels for non-solar applications to form a roofing system for a building, structure, or canopy. Methods related to the manufacture and assembly of the roofing systems disclosed herein are also provided.

Thus, it is an object of the presently disclosed subject matter to provide roofing systems that support the integration of solar panels or insulated roofing panels for non-solar applications into the roof to form a roofing system fora building, structure, or canopy. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1A illustrates a perspective view of a structure with an embodiment of a roofing system that includes embodiments of solar panels as an outer surface of the roof according to the present subject matter;

FIG. 1B illustrates a cross-sectional view of another embodiment of a roofing system that includes embodiments of solar panels or insulated roofing panels that can form an outer surface of the roof according to the present subject matter;

FIG. 2A illustrates a perspective view of an example embodiment of a base building structure on which an embodiment of a roofing system according to the present subject matter can be installed;

FIG. 2B illustrates a perspective view of the base building structure according to FIG. 2A with embodiments of brackets of a roofing system according to the present subject matter being installed;

FIGS. 3A-3D illustrate perspective views of portions of the base building structure according to FIG. 2A with embodiments of support beams of a roofing system according to the present subject matter being secured to the base building structure by the brackets shown in FIG. 2B;

FIG. 4A illustrates a perspective view showing a portion of the base building structure according to FIG. 2A with embodiments of wire troughs installed on the support beams of the roofing system according to the present subject matter;

FIGS. 4B and 4C illustrate perspective views of portions of the base building structure according to FIG. 2A showing installation of wires into wire troughs shown in FIG. 4A according to the present subject matter;

FIG. 5A illustrates a longitudinal side plan view of an embodiment of a gasket used in conjunction with insulated roofing panels or solar panels of the roofing system according to the present subject matter;

FIG. 5B illustrates an end side plan view of an embodiment of the gasket as shown in FIG. 5A used in conjunction with roofing panels or solar panels of the roofing system according to the present subject matter;

FIGS. 6A, 6B, and 6C illustrate perspective views of portions of the base building structure according to FIG. 2A showing installation of gaskets on the support beams of the roofing system according to the present subject matter;

FIGS. 7A, 7B, and 7C illustrate perspective views of portions of the base building structure according to FIG. 2A showing installation of solar panels/roofing panels on the support beams of the roofing system according to the present subject matter;

FIGS. 8A and 8B illustrate perspective views of portions of the base building structure according to FIG. 2A showing installation of top caps over the solar panels/roofing panels and secured on the support beams of the roofing system according to the present subject matter;

FIGS. 9A and 9B illustrate perspective views of portions of the base building structure according to FIG. 2A showing installation of top caps over the solar panels/roofing panels and secured on the support beams of the roofing system according to the present subject matter;

FIG. 10A illustrates a cross-sectional view of another embodiment of a support beam of a roofing system that includes embodiments of gaskets, end fins, a wire trough and a top cap according to the present subject matter;

FIG. 10B illustrates a cross-sectional view of another embodiment of a support beam of a roofing system that includes embodiments of a wire trough and a top cap according to the present subject matter;

FIGS. 11A and 11B illustrate cross-sectional views of portions of an embodiment of the roofing system according to present subject matter showing the solar modules secured between the gaskets of the roofing system;

FIGS. 12A and 12B illustrate perspective views of the base building structure according to FIG. 2A with an embodiment of the roofing system that includes embodiments of solar modules as an outer surface of the roof according to the present subject matter;

FIG. 13A illustrates a cross-sectional view of a portion of an embodiment of the roofing system according to present subject matter showing the solar modules laid side-by-side with a seal secured between the solar modules;

FIG. 13B illustrates a cross-sectional view of a portion of an embodiment of the roofing system according to present subject matter showing the solar modules laid side-by-side as shown in FIG. 13A and secured between the gaskets of the roofing system; and

FIG. 13C illustrates an end side plan view of an embodiment of the gaskets as shown in FIG. 13B used in conjunction with roofing panels or solar panels of the roofing system according to the present subject matter.

Repeat use of reference characters in the present specification and drawings is intended to represent the same or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer or section. Thus, a first feature, element, component, region, layer or section discussed below could be termed a second feature, element, component, region, layer or section without departing from the teachings of the disclosure herein.

Similarly, when a component, layer or coating is being described in the present disclosure as “on” or “over” another component, layer or substrate, it is to be understood that the components or layers can either be directly contacting each other or have another component, layer or feature between the components or layers, unless expressly stated to the contrary. Thus, these terms are simply describing the relative position of the components or layers to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5 as examples.

As used herein, the term “solar modules” and “solar panels” are generally used interchangeably and refer to a single photovoltaic panel that is an assembly of connected solar cells. The solar cells absorb sunlight as a source of energy to generate electricity. An array of solar modules can be used to collect and supply power to a variety of structures and/or apparatuses.

As used herein, the term “roofing panels” is used broadly to mean any type of roofing panel and can include, but is not limited to solar modules, or solar panels, insulated roofing panels that do not include solar cells, or other roofing panels.

As used herein, the term a “plurality” means two or more.

The present disclosure relates to a roofing system for forming a roof of a structure that can include solar modules and/or insulated roofing panels, i.e., weatherproof roofing panel, which in some embodiments can be insulated metal plates, that form the majority of the outer surface of the roof. The roofing system can comprise one or more structural beams that can be secured to the structure being roofed that act as support beams to provide support to the roof. Each of the one or more structural beams can comprise an extruded aluminum structural beam. Roofing panels can be provided that comprise at least one of the insulated roofing panels or the solar modules respectively. The roofing system can comprise one or more top caps corresponding to the number of the structural beams. The one or more top caps can be configured to secure the roofing panels in place on the one or more structural beams. To protect, secure and seal the roofing panels in position relative to the structural beams and the top caps, gaskets can be provided for sealing the roofing panels. The roofing system can additionally comprise end fins attachable to at least one of the structural beams or the top caps to enclose end edges of the roofing system. Further, the roofing system can include one or more interior gutters built into each of the structural beams to drain any water that may leak through between the gaskets and the roofing panels.

In some embodiments where solar modules are used as roofing panels, the roofing system can comprise wire troughs configured to accommodate wiring for solar modules used as roofing panels. Each of the wire troughs can be attached to a side of a structural beam. Additionally, in such embodiments, the one or more structural beams can further comprise a bonding rail. The bonding rail, or bonding jumper rail, can be used for clipping standard UL listed bonding jumpers between a solar module and a beam. Additionally, in some embodiments, the bonding rail can also be used to clip optimizers/microinverters in the same way these devices clip to a solar module frame.

In some embodiments, the structural beams can comprise one or more T-bolt slots therein. The T-bolt slots, for example, can be used for attaching wire troughs and attaching insulation covers and other accessory attachment as well as for securing bolts to the respective structural beam for securement of structural attachment brackets for securing the respective structural beam to a building structure being roofed. Each of the structural beams can also comprise a threaded channel on a top portion of the respective structural beam for securing a top cap to the respective structural beam.

The roofing system disclosed herein is not only novel to the solar industry, it is also novel to the general construction industry as well. The roofing system allows for a less expensive and more durable alternative for the general construction industry for new buildings, modular or prefab homes, and kit construction, such as for homes and outbuildings. The roofing system disclosed herein can be considered “kit-like” in that it can come partially pre-assembled and can include easy to assemble components. It can also increase the accessibility of building integrated photovoltaics (“BIPV”) for a number of building types, reducing both a cost and complication barrier to installation.

In roofing and general construction, the use of the structural beams of the roofing system disclosed herein can allow for large unsupported spans while creating a roofing system with a far superior lifespan compared to traditional roofing methods. The weatherproof roofing panels, which can comprise insulated metal plates, can be sandwiched into the beam system between the structural beams and the top caps. As stated above, this beam system can incorporate an internal backup gutter system to facilitate the removal of moisture from the roofing system. Thus, whether or not solar photovoltaic solar modules are integrated therein, the roofing system disclosed herein will create a durable, sound roofing structure for a variety of structure types.

Thus, the present disclosure provides a roofing system that uses structural beams and top caps that can secure and hold multiple types of solar modules and insulated weatherproof roofing panels in a watertight, shingle-like assembly using roofing panel gaskets in a racking system, thereby providing a racking system that is integrated into the roofing structure of a building. The entire roofing system is designed to meet the typical structural requirements of a roof and/or solar array with a unique design, as explained further below with reference to the figures, that provides an all-in-one solution with long-term structural and watertight fortitude.

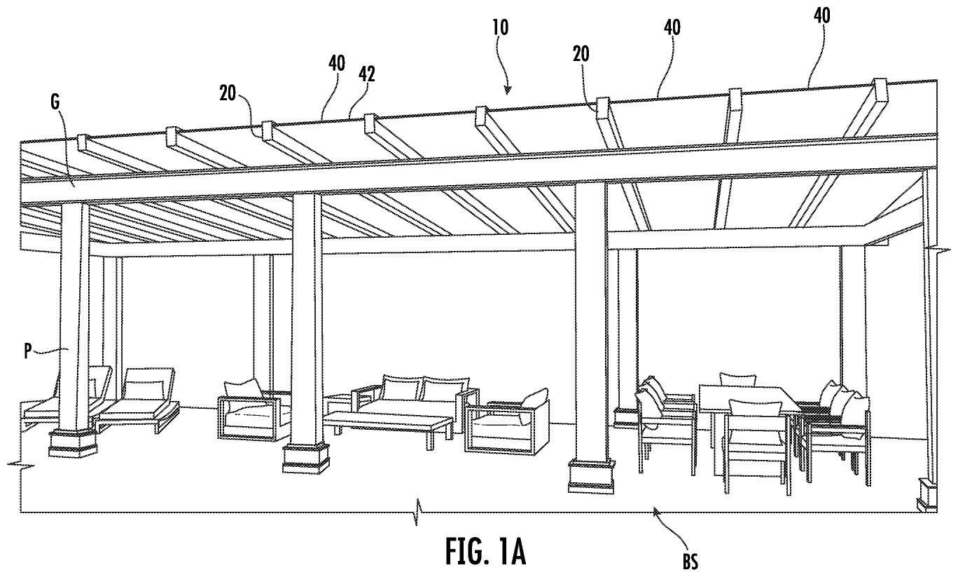

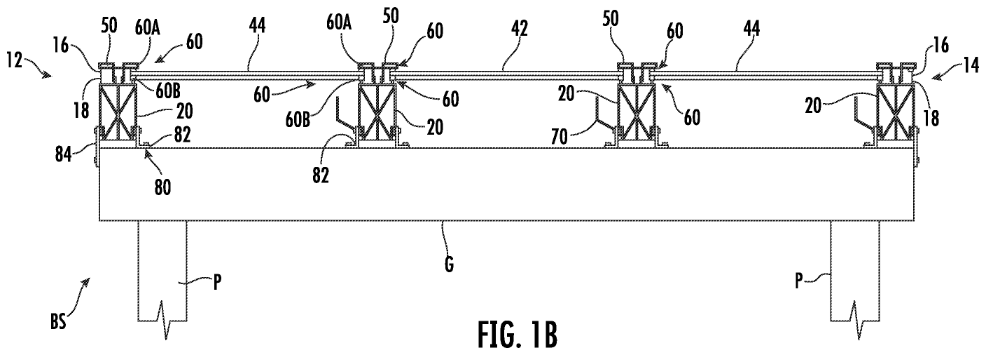

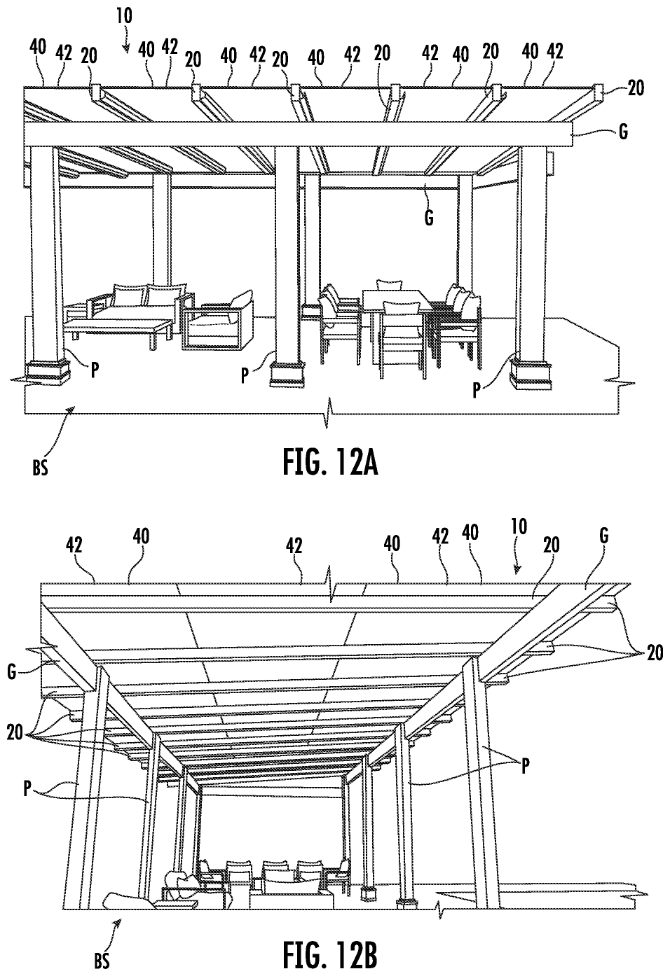

A building structure, generally, BS, is provided as shown in FIGS. 1A, 1B, 12A and 12B that includes a roofing system, generally designated 10, that can incorporate roofing panels that can be either solar modules or insulated roofing panels. Thus, a roofing system 10 can be provided that operate as a regular roofing structure or a roofing structure that operates as both a roof and an integrated solar rack. The building structure BS is used herein simply for illustrative purposes only. It is noted that the roofing system 10 can be used on any type of building and an array of roofing styles.

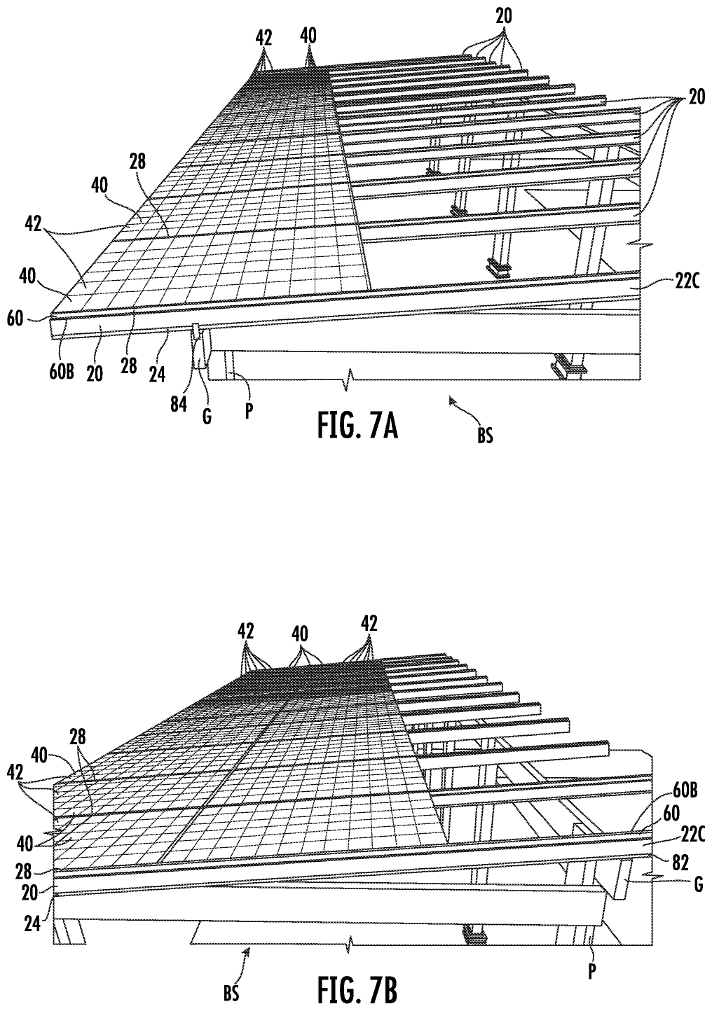

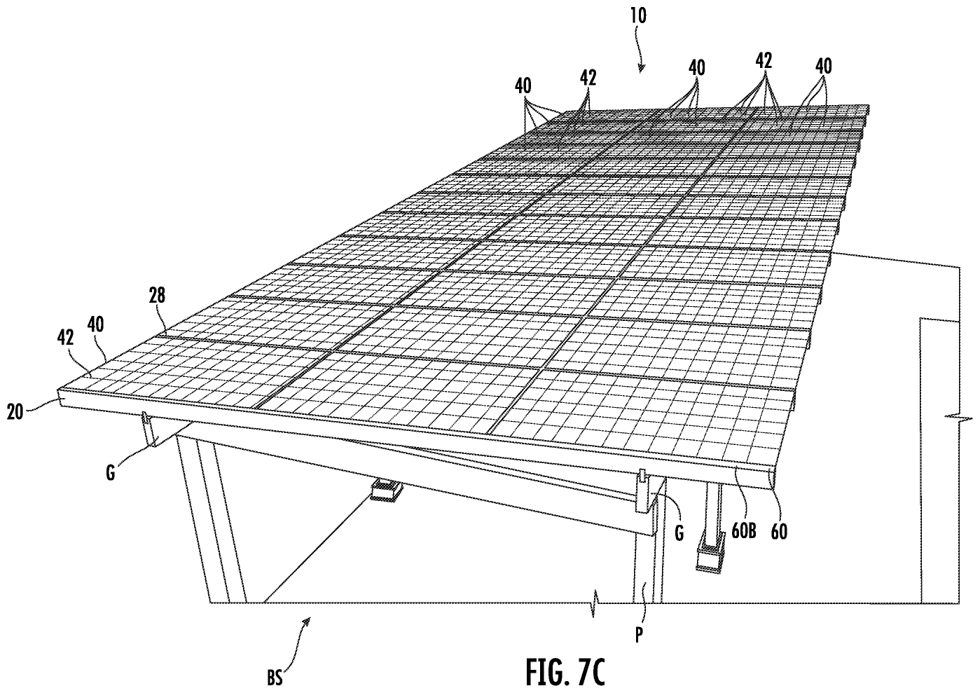

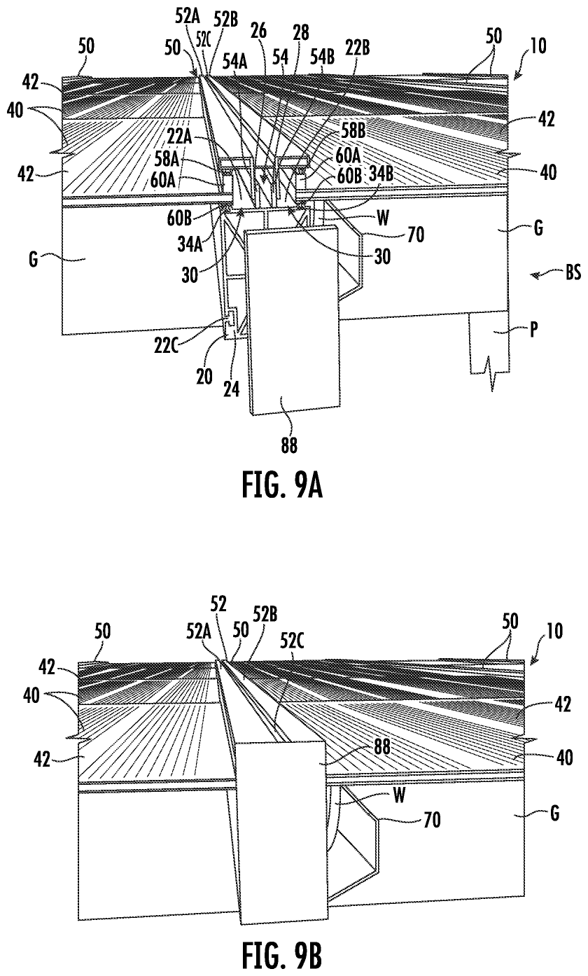

Referring to FIGS. 1A-12B, the roofing system 10 is provided that can comprise multiple components, including structural beams 20 and roofing panels 40 that can be manufactured in a variety of sizes to support a range of spans. The roofing system 10 incorporates top caps 50 and gaskets 60 such that the structural beams 20 receives the top caps 50 with the gaskets 60 securing and holding the roofing panels 40 between the structural beams 20 and the top caps 50. The roofing system 10 with the structural beams 20, the top caps 50, and the gaskets 60 can be used to support roofing panels 40 that can be either solar panels, i.e., solar modules, 42 or insulated roofing panels, i.e., weatherproof roofing panels, 44 to create a completely watertight structure.

When the roofing system 10 is used as only a roofing structure, the insulated panels 44 (as shown in FIG. 1B) can be sandwiched between the rubber gaskets 60 positioned on the top caps 50 and the beams 20. The structural beams 20 can act as rafters and the insulated roof panels 44 act as sheathing and roofing material. Each of the structural beams 20 can include an interior gutter 30 that captures any moisture that may get past the gaskets 60 serving as a safety net for the watertight seal. That water would then run through an inside gutter channel 30 within the respective structural beam 20 and come out the end outside of the underlying structure maintaining its watertight seal.

When used to create a solar integrated roofing structure, the solar modules 42 can be similarly sandwiched between the rubber gaskets 60 positioned on the top caps 50 and the beams 20. Stepped gaskets 60 can be used to allow the solar modules 42 to slightly overlap like a shingle would. A sealant can be used between the solar modules. For example, a double-sided butyl tape can be placed in between the overlap to seal the overlapping solar modules 42 to along the overlap. Unlike conventional solar racking structures commonly used, this tape is not exposed to the elements and therefore does not have a limited lifespan. The same or similar sealants can be used between insulated roofing panels 44. The solar modules 42 can then be bonded to the bonding rail on the beam using a bonding jumper to create an obvious visible bond between the solar modules 42 and the respective structural beam 20. This bonding is required in a solar installation due to the electrical components. A wire trough 70 can be slid into the respective structural beam 20 for wire management and/or micro-inverter/optimizer mounting to hide and protect wiring in between the solar modules 42. This application contains the same gutter structure 30 as the roofing structure using insulated roofing panels applications.

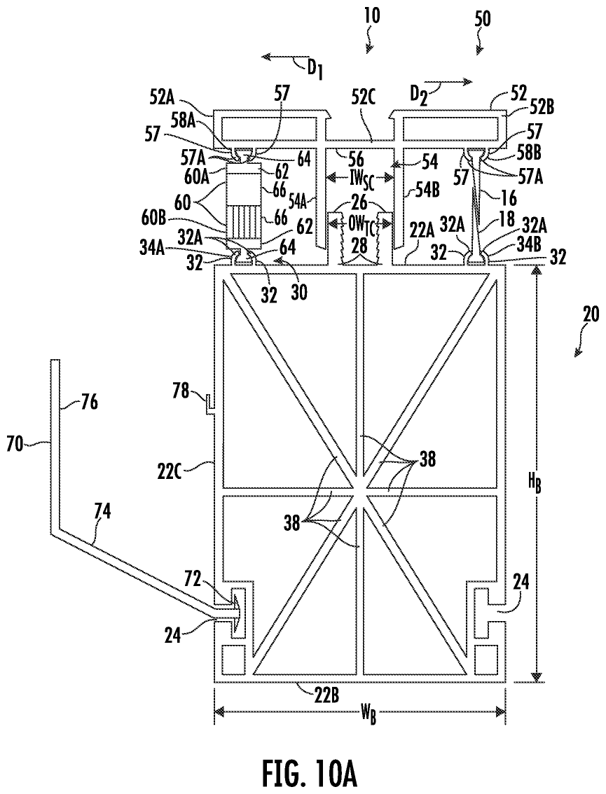

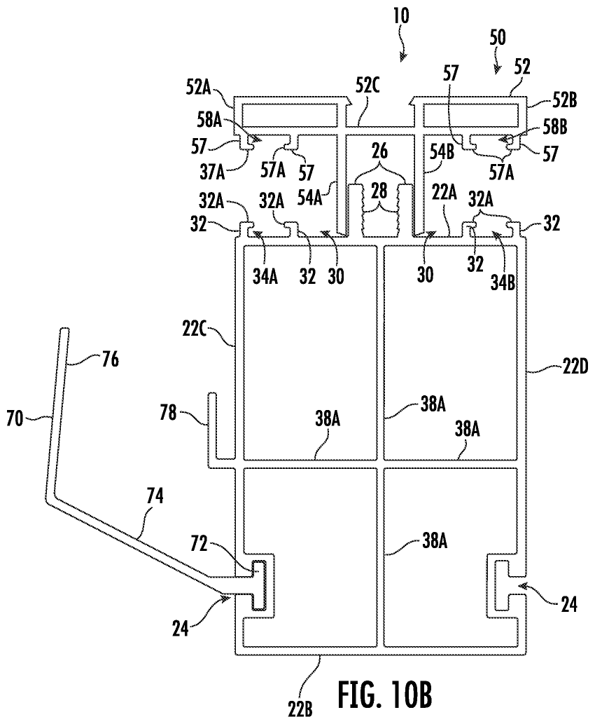

An exemplary embodiment of the roofing system 10 as shown in FIGS. 1A, 1B, and 3A-12B will now be described in more detail. The roofing system 10 can comprise two or more, or a plurality of, structural beams 20 with each of the structural beams 20 comprising an extruded structural beam. The structural beams 20 can comprise a metal. For example, the structural beams 20 can comprise extruded aluminum. As shown in FIG. 10, each structural beam 20 can comprise a top wall 22A and a bottom wall 22B and two opposing side walls 22C, 22D. The structural beam 20 can comes in various dimensions depending on the building structure with which it will be used. For example, for standard solar mounting applications with maximum span of about 6 ft., the cross-sectional dimensions of the beam 20 can be about 3.5 inches in width WB by about 3 inches in height H_{B}. For spans up to about 12 ft., the cross-sectional dimensions of the beam 20 can be about 3.5 inches in width WB by about 6 inches in height H_{B}. For spans up to about 16 ft., the cross-sectional dimensions of the beam 20 can be about 3.5 inches in width WB by about 8 inches in height H_{B}. For spans up to about 18 ft., the cross-sectional dimensions of the beam 20 can be about 3.5 inches in width WB by about 10 inches in height H_{B}. The thickness of the top wall 22A, the bottom wall 22B, and two opposing side walls 22C, 22D may vary as well, depending on the length of the span of the structural beam 20. Additionally, the structural beam 20 can include reinforcement support tabs 38, 38A within an interior of the structural beam 20 that can be provided at different angles to provide increased structural integrity and support to the structural beam 20 to help withstand the different types of stresses and forces placed on the beams 20. For example, as shown in FIG. 10A, the support tabs 38 within the interior of the structural beam 20 can include support tabs 38 that run at acute angles to the walls 22A, 22B, 22C and 22D of the structural beam 20 as well as support tabs 38 that are about perpendicular, or normal, to the respective walls 22A, 22B, 22C and 22D of the structural beam 20 from which they extend to provide increased structural integrity and support to the structural beam 20. In some embodiments, as shown in FIG. 10B, the support tabs 38A within the interior of the structural beam 20 may include only support tabs 38 that are about perpendicular, or normal, to the respective walls 22A, 22B, 22C and 22D of the structural beam 20 from which they extend to provide increased structural integrity and support to the structural beam 20.

T-bolt slots 24 can be formed in at least one of the side walls 22C, 22D of each extruded beam 20 of receiving accessory attachments. For example, the T-bolt slots 24 can be used for attaching a wire trough 70 and/or for inserting bolts 82 into the respective structural beam 20 for attachment of structural attachment brackets 80 for securing the respective structural beam to a building structure BS being roofed. In some embodiments, brackets having a T-shaped engagement can be slid into the T-bolt slots 24 for securing the respective structural beam to a building structure BS being roofed. The T-bolt slots 24 in each of the structural beams 20 can be formed in the respective structural beam 20 during extrusion of the respective structural beam 20.

Additionally, the T-bolt slot channels 24 positioned proximate to the bottom 22B of the structural beams 20 can be used to install a bottom cap (not shown). This makes it easy to insulate the spaces between the structural beams 20 for a higher R-Value when used in general construction or building integrated photo-voltaics (“BIPV”) applications and it is enclosed with a covering.

Each structural beam 20 can also comprise channel walls 26 that can extend upward from the top wall 22A of the extruded beam 20. The channel walls 26 can form a threaded channel 28 for securing a respective top cap 50 to the respective structural beam 20. The threaded channel 28 on the top portion, i.e., the top wall 22A of the respective structural beam 20 can be formed as an integral part of the respective structural beam 20 during the extrusion process.

Additionally, as shown in FIGS. 10A and 10B, each structural beam 20 can comprise gasket channel walls 32 extending upward from the top wall 22A of the extruded beam 20. The gasket channel walls 32 form one or more gasket attachment channels 34A, 34B for securing gaskets 60 to the extruded beam 20. Thereby, each structural beam 20 can be used to secure a bottom gasket 60B of the gaskets 60 such that the bottom gasket 60B can form a seal between the roofing panels 40 and the respective structural beam 20 when the components are installed in the roofing system 10. As in the embodiment shown in FIGS. 10A and 10B, the structural beam 20 can have a first gasket attachment channel 34A on a first side of the top wall 22A of the structural beam 20 and a second gasket attachment channel 34B on a second side of the top wall 22A of the structural beam 20 to accommodate bottom gaskets 60B for securement of roofing panels 40 on either side of the structural beam 20. Depending on where the structural beam 20 is used in the roofing system 10, for example, if the structural beam 20 is a beam that forms an end edge of the roofing system 10, the gasket attachment channel 34A, 34B that forms the outer gasket attachment channel can be used for securing one of the end fins 18 to the respective structural beam 20. Each of the gasket attachment channels 34A, 34B of the respective structural beam 20 can be formed as an integral part of the respective structural beam 20 during the extrusion process. As shown in FIGS. 10A and 10B, the gasket channel walls 32 can have lips 32A that extend farther inward into the channel than the base of the gasket channel walls 32 such that the base of the respective gasket attachment channel 34A, 34B is wider than its entrance. This configuration of the gasket attachment channels 34A, 34B create a holding mechanism for securing bottom gaskets 60B or end fins 18 to the structural beam 20 with an easy-to-use sliding engagement.

Each structural beam 20 can also comprise one or more interior gutters 30 built into the structural beam 20 to drain any water that may leak between the gaskets 60 and the roofing panels 40 of the roofing system 10. In particular, the interior gutters 30 can be formed along the top wall 22A of the extruded beam 20. In some embodiments, for example, two interior gutters 30 can be formed on either side of the threaded channel 28 between channel walls 26 that form the threaded channel 28 extending upward from the top wall 22A and gasket channel walls 32 that form one or more gasket attachment channels 34A, 34B also extending upward from the top wall 22A. The channel walls 26 of the thread channel 28 and the channel walls 32 of the gasket attachment channels 34A, 34B on structural beam 20 with either a gasket 60 or an end fin 12 therein can thereby forms side walls of the one or more interior gutters 30.

As disclosed above for embodiments of the roofing system 10 that are a solar integrated roofing structure, the roofing system 10 can also comprise wire troughs 70 configured to accommodate wiring for solar modules 42 used as roofing panels. Each wire trough, or wire trough attachment, 70 can be attached to a side wall 22C, 22D of the structural beam 20. As explained above, in some embodiments, a wire trough attachment 70 can be configured to engage a T-bolt slot 24 in a side wall 22C, 22D of structural beam 20. The wire trough 70 is configured to accommodate wiring for solar modules 42 used as roofing panels 40 in conjunction with the structural beam 20 to form the roofing system 10. For example, referring to FIGS. 10A and 10B, the wire trough 70 can be slid into a T-bolt slot 24 formed in the structural beam 20. In such embodiments, each wire trough 70 can include a T-shaped base 72 that is configured to fit into one of the T-bolt slots 34 formed in a side wall 22C, 22D of the structural beam 20 to firmly hold the respective wire trough 70 in place on the structural beam 20. Each wire trough 70 can also comprise a trough body 74 that extends out from the T-shaped base 72. In some embodiments, the body 74 of the wire trough 70 can form the cavity of the trough between a wall 76 of the body 74 of the wire trough 70 and the side wall 22C, 22D of structural beam 20 to which the wire trough 70 is secured.

Each structural beam 20 can also comprise a bonding rail 78 as shown in FIGS. 10A and 10B, for example. The bonding rail 78 can extend outward from one of the side walls 22C, 22D of the extruded beam 20 above a T-bolt slot 24 in a side wall 22C, 22D of structural beam 20. In some embodiments, the bonding rail 78 can be formed as an integral part of the extruded beam 20 during the extrusion process. For example, the bonding rail 78 can be on a side of a side wall 22C, 22D of structural beam 20 to which the wire trough 70 is attached. In this manner, a standard UL listed bonding jumper can be attached or clipped to the bonding rail 78 between solar module 42 and structural beam 20. Similarly, optimizers and/or microinverters can be attached or clipped to the bonding rail 78 in same way with the wire trough 70 hiding the wiring and microinverters and/or optimizers.

The roofing system 10 can comprise roofing panels 40 as shown in FIGS. 1B and 7A-9B. The roofing panels 40 can comprise at least one of insulated roofing panels 44 or solar modules 42. When the roofing panels 40 comprise solar modules 42, the structural beams 20, the top caps 50 and the gaskets 60 form an integrated solar racking system that forms a roof of a structure.

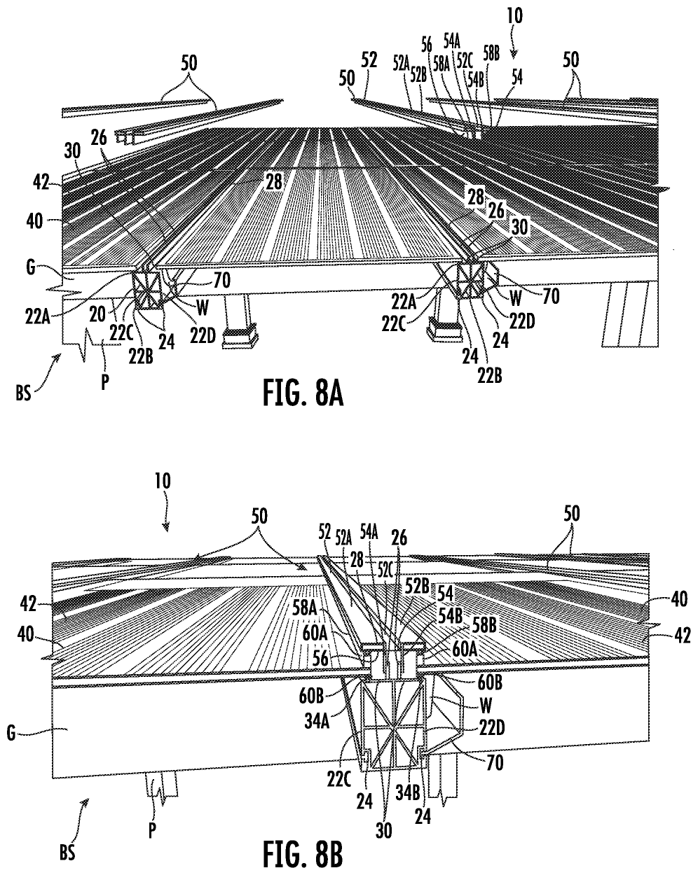

The roofing system 10 can also comprise top caps 50 corresponding to the number of the one or more structural beams as shown in FIGS. 8A-10. The top caps 50 can comprise a metal. For example, the top caps 50 can comprise extruded aluminum. The top caps 50 can be configured to secure the roofing panels 40 in place on the structural beams 20. The top caps 50 can have one or more gasket attachment channels 58A, 58B for securing top gaskets 60A of the gaskets 60 for forming a seal between the roofing panels 40 and the respective top cap 50.

In some embodiments, each top cap 50 can comprise a top portion 52 that includes a first flange 52A extending in a first direction D₁ and a second flange 52B extending in an opposing second direction D₂ with a securement indention 52C between the first and second flange 52A, 52B for receiving a fastener therein to engage the threaded channel 28 of the structural beam 20. Each top cap 50 can comprise a securement positioning channel 54 that extends from a bottom portion 56 of the top cap 50.

The securement positioning channel 54 can align with the securement indention 52C between the first and second flanges 52A, 52B and can have securement channel walls 54A, 54B that extend from the bottom portion 56 of the top cap 50 to form the securement positioning channel 54. In some embodiments, the securement channel walls 54A, 54B can be separated by a distance such that the securement positioning channel 54 has an inner width IW_{SC} as measured from the inner surfaces of the securement channel walls 54A, 54B that is slight wider than the outer width OW_{TC} of the threaded channel 28 as measured from the outer surfaces of the channel walls 26 of the threaded channel 28. Thus, when the top cap 50 is placed on the structural beam 20 to be secured thereto, the securement positioning channel 54 of the top cap 50 is placed over the threaded channel 28 of the structural beam 20 such that channel walls 26 of the thread channel 28 fit within the securement channel walls 54A, 54B to align the securement indention 52C with the thread channel 28 for inserting one or more fasteners through pre-drilled holes (not shown) in the securement indention 52C and into the thread channel 28. Additionally, the fitting of the securement channel walls 54A, 54B of the securement positioning channel 54 of the top cap 50 over the channel walls 26 of the thread channel 28 of the structural beam 20 can also align the gasket attachment channels 58A, 58B for securing top gaskets 60A of the gaskets 60 to the top cap 50 with the gasket attachment channels 34A, 34B of the structural beam 20 for securing bottom gaskets 60B of the gaskets 60 to the structural beam 20. This alignment of the top gasket attachment channels 58A, 58B with bottom gasket attachment channels 34A, 34B of the structural beam 20 ensure proper securement and sealing of the roofing panels 40 and the roofing system 10 that forms a roofing structure for a building structure BS.

To form the top gasket attachment channels 58A, 58B, each top cap 50 can comprise top gasket channel walls 57 extending downward from the bottom portion 56 of the top cap 50. The top gasket channel walls 57 can be positioned on the first and second flange 52A, 52B of the top cap 50 forming top gasket attachment channels 58A, 58B on both sides of the top cap 50 to align with the gasket attachment channels 34A, 34B of the structural beam 20 when the top cap 50 is secured thereto. In particular, as in the embodiments shown in FIGS. 10A and 10B, the top cap 50 can have a first top gasket attachment channel 58A on the first flange 52A of the structural beam 20 and a second top gasket attachment channel 58B on the second flange 52B of the top cap 50 to accommodate top gaskets 60A for securement of roofing panels 40 on either side of the top cap 50. Depending on where the top cap 50 is used in the roofing system 10, for example, if the top cap 50 is a beam that forms an end edge of the roofing system 10, the outer top gasket attachment channel 58A, 58B can be used for securing the end fin 16 to the respective top cap 50. Each of the top gasket attachment channels 58A, 58B of the respective top cap 50 can be formed as an integral part of the respective top cap 50 during the extrusion process. As shown in FIGS. 10A and 10B, the top gasket channel walls 57 can have lips 57A that extend farther inward into the channel than the base of the top gasket channel walls 57 such that the base of the respective top gasket attachment channel 58A, 58B is wider than an entrance of the respective top gasket attachment channel 58A, 58B. As with the gasket channels of the structural beam 20, these configurations of the top gasket attachment channels 58A, 58B create a holding mechanism for securing top gaskets 60A or end fins 16 to the top cap 50 with an easy-to-use sliding engagement.

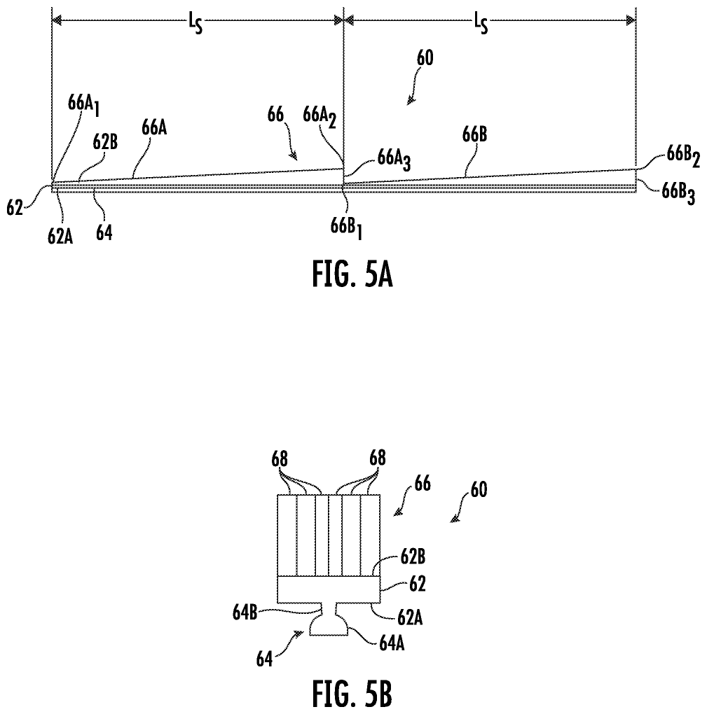

The roofing system 10 can further comprise roofing panel gaskets 60 for sealing the roofing panels as shown in FIGS. 5A-6C and 10-11B. The gaskets 60 can comprise stepped gaskets when using shorter roof panels that overlap or a flat gasket (discussed below). The gaskets 60 can comprise a rubber. For example, the gaskets 60 can comprise a synthetic rubber. In some embodiments, the gaskets 60 can comprise an ethylene propylene diene monomer rubber (EPDM) that can provide a seal between the gaskets 60 and the roofing panels 40 and be sturdy enough to support the roofing panels 40 between the structural beams 20 and the top caps 50 and generally be expected to last the life of the roof structure. For example, the gaskets 60 can be top gaskets 60A or bottom gaskets 60B depending on how the gaskets 60 are oriented and which of the gasket attachment channels 34A, 34B, 58A, 58B the gaskets 60 engage.

Referring to FIGS. 5A and 5B, the roofing panel gasket 60 can comprise a longitudinal base 62 having a first side 62A and a second side 62B running the length of the base 62. An engagement rail 64 can extend outward from the first side 62A of the base 62. The engagement rail 64 can be configured to attachably engage a respective gasket attachment channel 34A, 34B, 58A, 58B in either a structural beam 20 or a top cap 50 of a roofing system 10. For example, in some embodiments, the engagement rail 64 can comprise a rail track 64A that can be inserted into a base of a gasket attachment channel 34A, 34B, 58A, 58B and a stem 64B that extends between the longitudinal base 62 and the rail track 64A. The rail track 64A can be larger in width than at least a lower portion of the stem 64B such the rail track 64A can slidably fit within a base of a gasket attachment channel 34A, 34B, 58A, 58B while the lower portion of the stem 64B can slidably fit between the respective lips 32A, 57A of the gasket channel walls 32, 57 of the respective gasket attachment channels 34A, 34B, 58A, 58B.

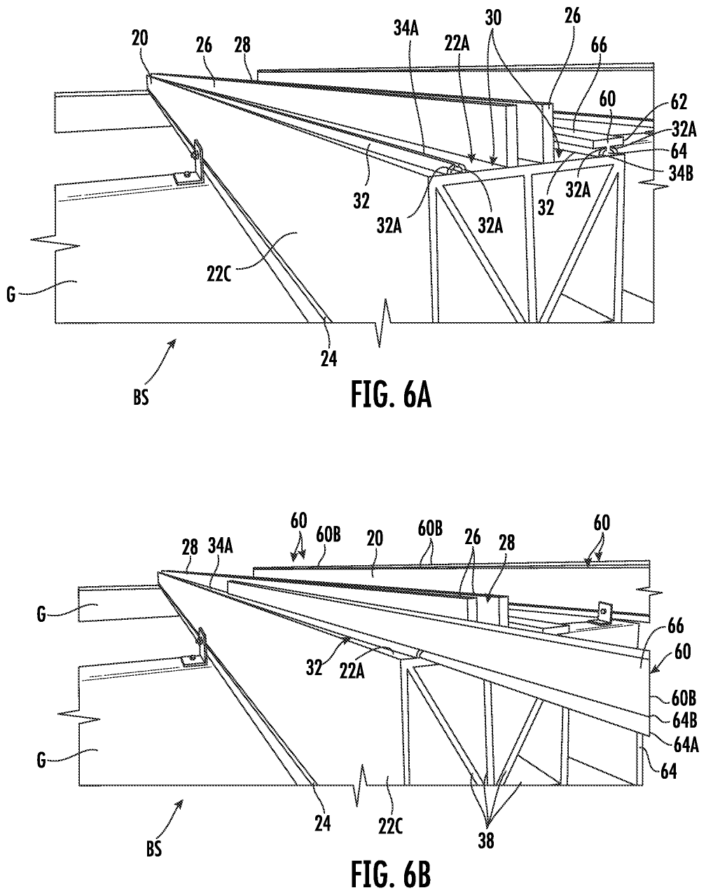

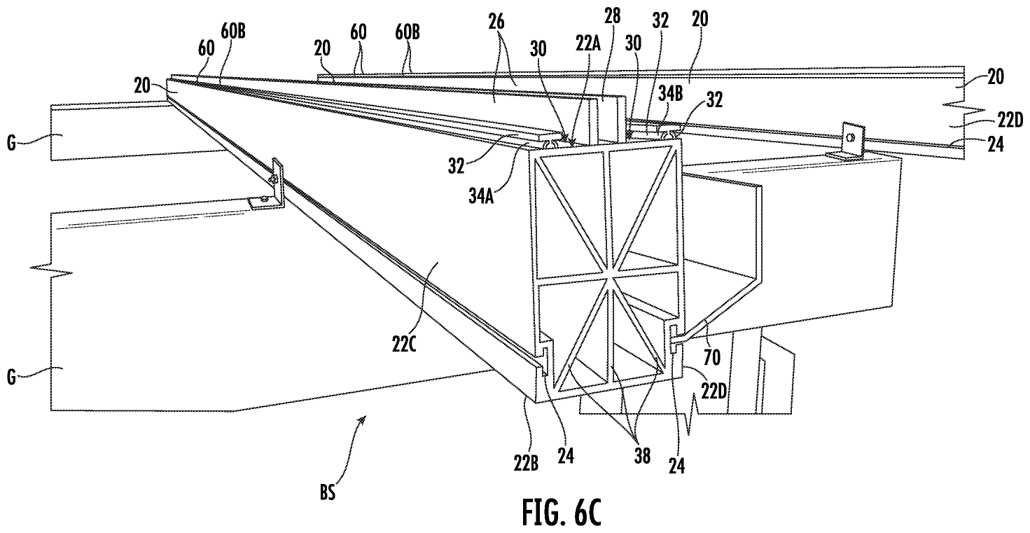

Each roofing panel gasket 60 can comprise a sealing body 66 that can extend upward from the second side 62B of the longitudinal base 62. The sealing body can comprise a flat surface to form a flat gasket (discussed below). Alternatively, the sealing body 66 can be a stepped longitudinal sealing body extending upward from the second side 62B of the longitudinal base 62 as shown in FIG. 5A that can be used in conjunction with a roofing system 10 where the roofing panels 40 overlap along the span length of a structural beams 20 as shown in FIGS. 6C-8B and 11A-11B. A sealant can be placed between the overlapping roofing panels 40 to seal the overlapping roofing panels not engaged by the roofing panel gaskets 60. For example, in some embodiments, a double-sided butyl tape can be placed in between the overlap roofing panels 40.

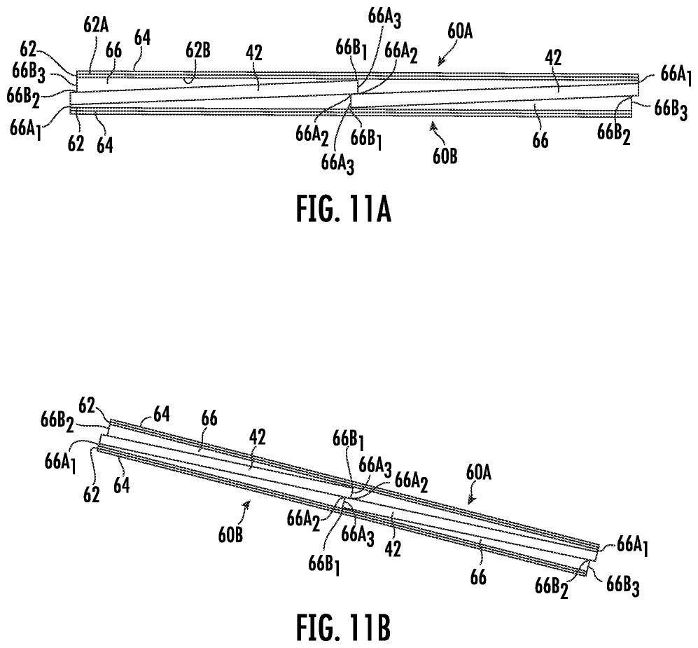

Referring back to FIGS. 5A and 11A-11B, the stepped longitudinal sealing body 66 can comprise a first step section 66A extending longitudinally at an angle from the second side 62B of the longitudinal base 62 such that a first end 66A₁ of the first step section 66A is shorter in height than a second end 66A₂ of the first step section 66A. The stepped longitudinal sealing body 66 can also comprise a second step section 66B following the first step section 66A. The second step section 66B can also extend longitudinally at an angle from the second side 62B of the longitudinal base 62 such that a first end 66B₁ of the second step section 66B is shorter in height than a second end 66B₂ of the second step section 66B. Each of the first and second step sections 66A, 66B can have a longitudinal length Lₛ, or wedge length, that is long enough to support and seal along a width of a roofing panel 40 while allowing an overlap of a roofing panel 40 placed on the first step section 66A with a roofing panel 40 placed on the second step section 66B. As an example, the lengths Lₛ of the first and second step sections 66A, 66B can be between about 38 inches and about 96 inches depending on the size of the roofing panels. In some embodiments, the lengths Lₛ of the first and second step sections 66A, 66B can be between about 40 inches and about 75 inches depending on the size of the roofing panels. For example, in some embodiments, the lengths Lₛ of the first and second step sections 66A, 66B can be about 40 inches. In some embodiments, the lengths Lₛ of the first and second step sections 66A, 66B can be about 65 inches. In some embodiments, lengths Lₛ of the first and second step sections 66A, 66B can be about 75 inches.

The second end 66A₁ of the first step section 66A can terminate to form an abutment wall 66A₃ that extends downward toward the second side 62B of the longitudinal base 62 to the first end 66B₁ of the second step section 66B with the abutment wall 66A₃ having a depth corresponding to a height of a roofing panel 40 to be placed on the second step section 66B. Depending on the size of the building structure BS and span length of a structural beams 20 used in the roofing system 10, multiple roofing panel gaskets 60 may be secured in each of the gasket attachment channel 34A, 34B, 58A, 58B. In such instances, the second end 66B₁ of the second step section 66B can operate in a similar manner to the second end 66A₁ of the first step section 66A. For example, when installed, the second end 66B₁ of the second step section 66B can terminate to form an abutment wall 66B₃ that extends downward toward the second side 62B of the longitudinal base 62. This abutment wall 66B₃ can be adjacent to a first end 66A₁ of a first step section 66A of an adjacent preceding roofing panel gasket 60 such that the abutment wall 66B₃ of the second step section 66B has a depth corresponding to a height of a roofing panel 40 to be placed on the first step section 66A of the adjacent preceding roofing panel gasket 60. The depth of the abutment walls 66A₃, 66B₃ when installed can vary depending on the height of the roofing panels 40 being used. For example, for frameless solar modules, the depth of the abutment walls 66A₃, 66B₃ when installed can be about 0.25 inches. For framed roofing panels (solar modules or insulated roofing panels), the depth of the abutment walls 66A₃, 66B₃ when installed can vary. For example, the depth of the abutment walls 66A₃, 66B₃ when installed can be between about 34 mm and about 42 mm depending on the height of the framed roofing panels. In some embodiments, the depth of the abutment walls 66A₃, 66B₃ when installed can be between about 32 mm and about 44 mm depending on the height of the framed roofing panels. For example, in some embodiments, the depth of the abutment walls 66A₃, 66B₃ when installed can be about 34 mm. In some embodiments, the depth of the abutment walls 66A₃, 66B₃ when installed can be about 37 mm. In some embodiments, the depth of the abutment walls 66A₃, 66B₃ when installed can be about 40 mm. In some embodiments, the depth of the abutment walls 66A₃, 66B₃ when installed can be about 42 mm.

In some embodiments, the roofing panel gasket 60 can have more than two step sections. For example, in some embodiments, the roofing panel gasket 60 can have three step sections or four step sections or more depending on the application.

As shown in FIG. 5B, in some embodiments, the stepped longitudinal sealing body 66 can comprise vertical sealing layers 68. The vertical layers 68 can each have the stepped longitudinal profile of the sealing body 66. The vertical layers 68 can create a better and longer lasting seal between roofing panel gasket 60 and the roofing panels 40.

The roofing system 10 can comprise end fins 16, 18 attachable to the structural beams 20 and the top caps 50 to enclose end edges 12, 14 of the roofing system 10 as shown in FIGS. 1B and 10. The end fins 16, 18 can overlap to form a seal at the end edges 12, 14. In some embodiments, the end fins 16, 18 can comprise a metal. In some embodiments, the end fins 16, 18 can comprise a plastic. For example, in some embodiments, the end fins 16, 18 can comprise a hard plastic or metal that can provide a seal at end edges 12, 14 of the roofing system 10 and be sturdy enough to generally be expected to last the life of the roofing system 10.

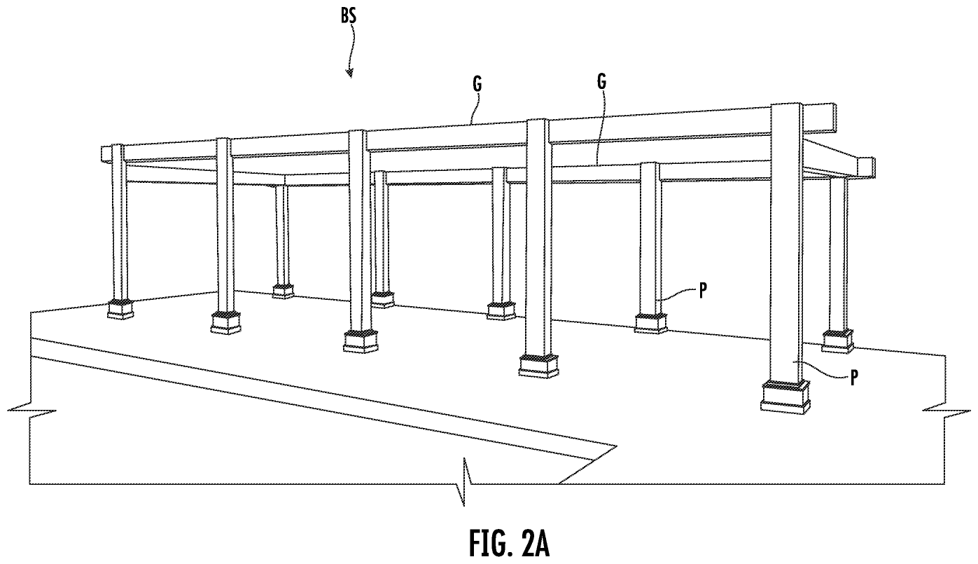

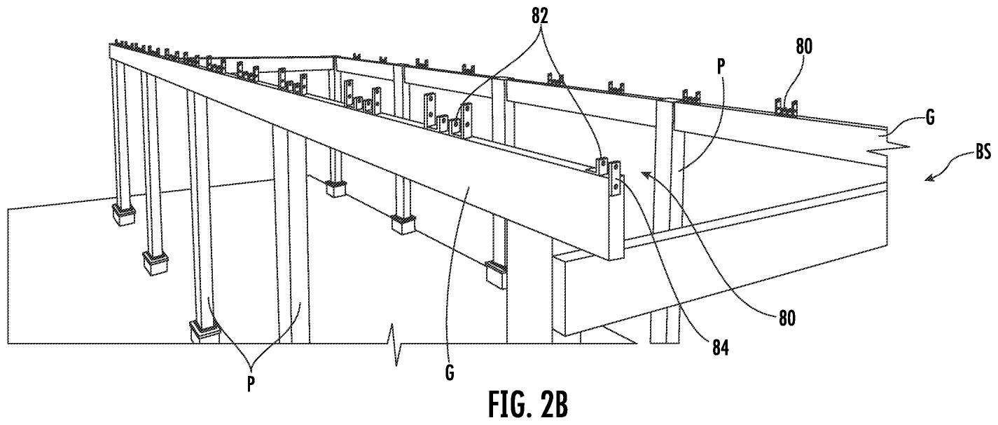

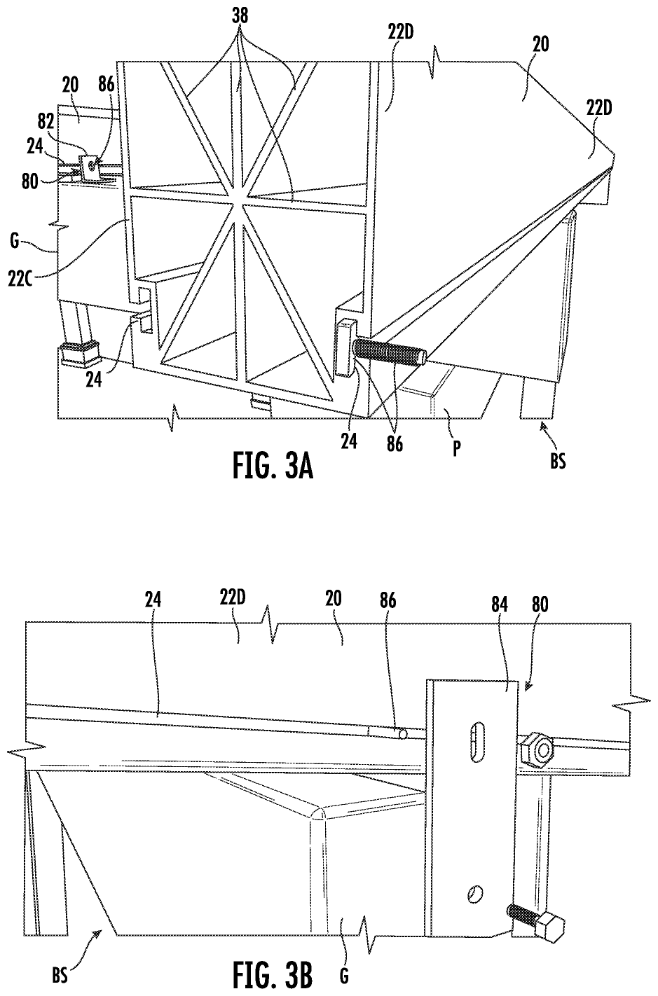

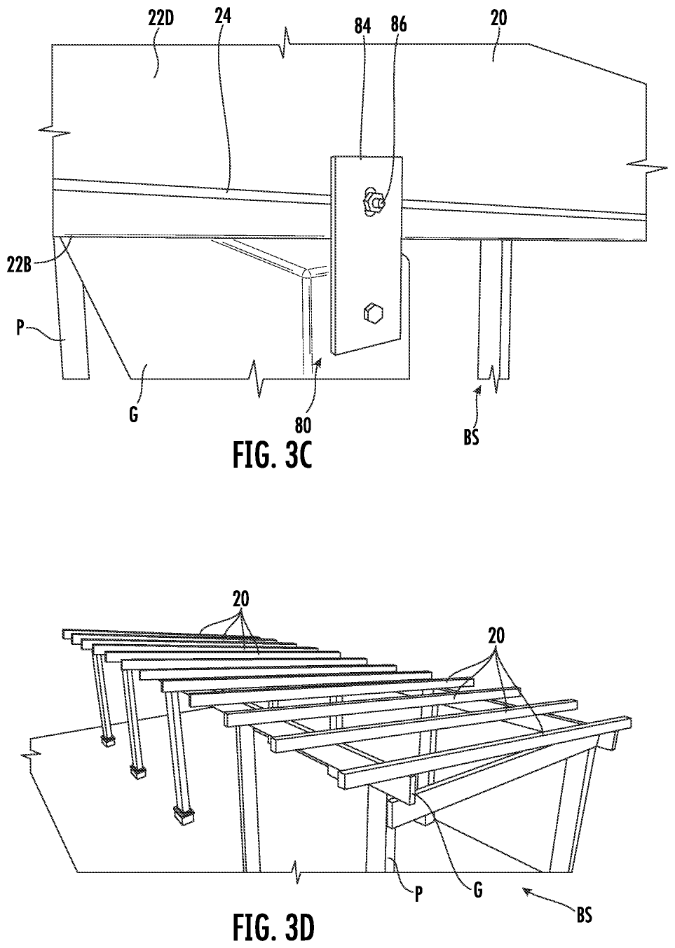

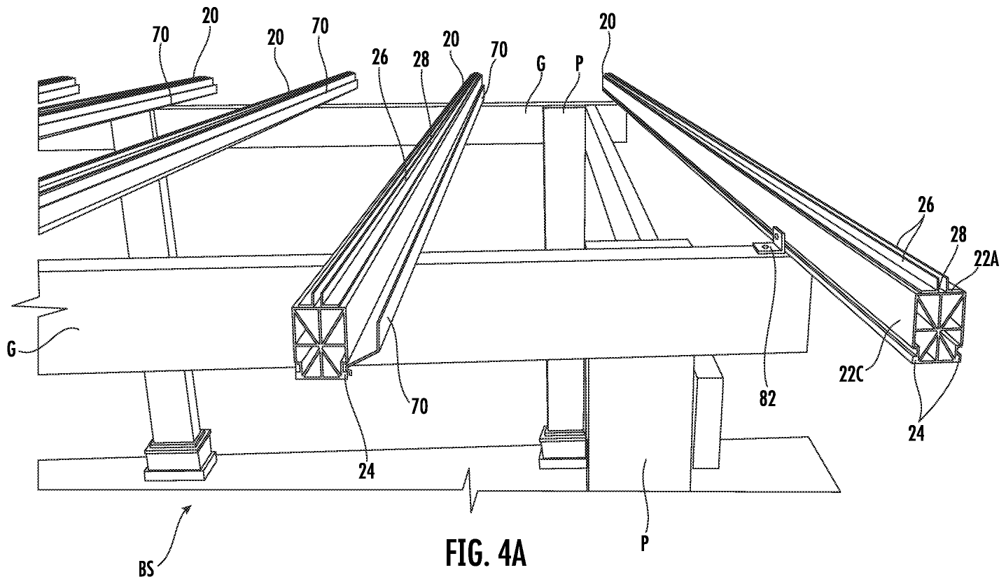

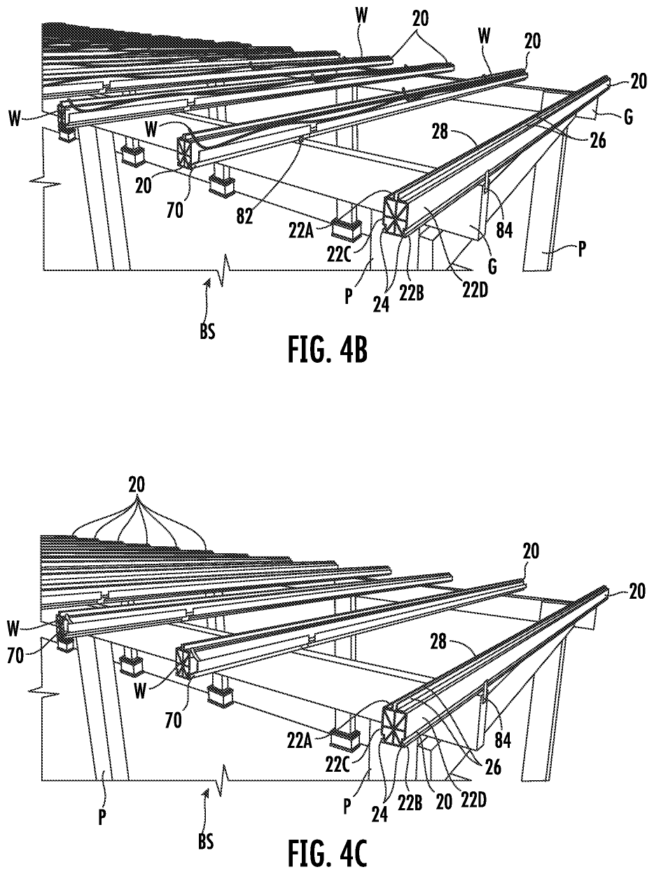

An example method for installing a roofing system 10 according to the present disclosure is provided as well in reference to FIGS. 2A-12B. As shown in FIG. 2A, a building structure BS to which the roofing system 10 is to be secured can be provided. As stated above, the building structure can be any type of building structure and the roofing system 10 can be used to provide a portion of or all of the roofing structure for a respective building structure. The example building structure BS can comprise support post P that support offset but parallel girders G. As shown in FIG. 2B-3D, mounting brackets 80 can be provided for securing structural beams 20 of the roofing system 10 as described above to the girders G. The mounting brackets 80 can comprise L-brackets 82 for securing the structural beams 20 on a top portion of the girders G and straight end brackets 84 that can be secured to the outer structural beams 20 at ends of the girders G. Securement T-bolts 86 can be slid into the T-bolt slots 24 in the side walls 22C, 22D of structural beam 20. Similarly, for embodiments of the roofing system 10 that use at least some solar modules 42 as roofing panels 40, wire troughs 70 can also be inserted in a T-bolt slot 24 in one of the side walls 22C, 22D of structural beam 20 which corresponds to the side on which the wiring, optimizers, and/or microinverters for the solar modules 42 to be installed in the roofing system 10 will reside as shown in FIGS. 4A and 4B. A bonding rail 78 may also be present on the same side wall 22C, 22D of structural beam 20 to which the wire troughs 70 are attached. The T-bolts 86 and wire troughs 70 are proper placed within the T-bolt slots 24 in the side walls 22C, 22D of structural beams 20, the mounting brackets 80 can be secured to both the girders G and the structural beams 20. Wiring W for the connection of the solar modules 42 can also be installed in the wire troughs 70 as shown in FIGS. 4B and 4C.

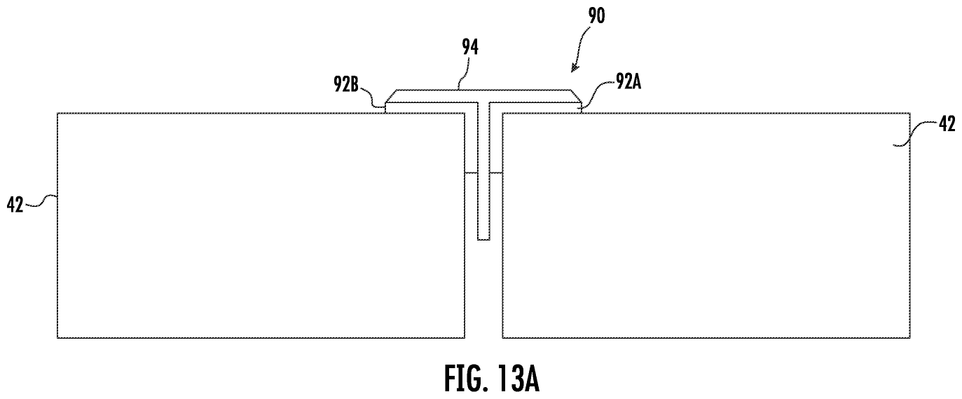

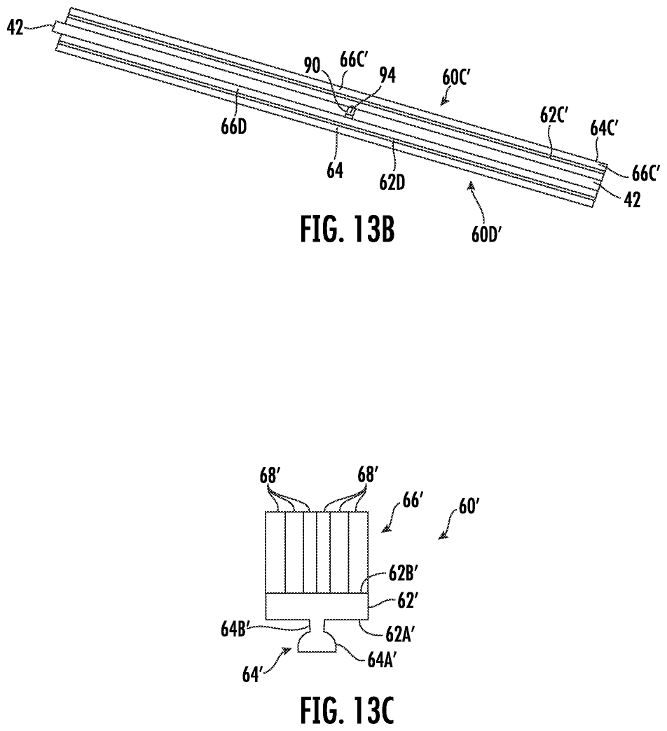

In some embodiments as shown in FIGS. 13A-13C, the roofing panels, such as solar modules or insulated roofing panels, can be secured side-by-side instead of stepped. For example, FIG. 13A shows two solar modules 42 can be placed on a gasket in a structural beam beside each other in close proximity. A panel seal 90 can be secured between the two solar modules 42 sealing the two solar modules 42 together. The panel seal 90 can comprise a sealer 92A, 92B, such commercial/roofing seam tape or a double-sided butyl tape, and a T-seal 94 that comprises a lateral top that extends over an end portion of the of the top of the two solar modules 42 and a tail that extends between the adjacent ends of the two solar modules 42. In some embodiments, the tape 92A can be placed over the top end portion and a portion of the end of the first solar module 42 and the tape 92B can be placed over the top end portion and a portion of the end of the second solar module 42. The T-seal 94, which can comprise a metal such as aluminum in the form of a T-bracket, can be press fit against the strips of tape 92A, 92B, on the top end portions and portions of the ends of the solar modules 42 to seal the gap between the two solar modules 42. Alternatively, the T-seal 94 can have the tape 92A, 92B, secured beneath the top of the T-seal 94 on either side of the tail of the T-seal 94. The solar modules 42 can be placed in a side-by-side configuration and the T-seal 94 with its tail and the tape 92A, 92B facing downward can be press fit between the two solar modules 42 to secure the T-seal 94 to the top of the end portions and the ends of the two solar modules 42 to seal the gap between the two solar modules 42. While the use of the panel seal 90 where roofing panels are placed side-by-side have been described with reference to solar modules 42, the panel seals 90 can be used with insulated roofing panels or a combination of different roofing panels. The tape 92A, 92B can be positioned on the T-seal 94 in such a way so as to limit the exposure of the tape to the elements once solar modules 42 or roofing panels and panel seal 90 are installed.

As shown in FIG. 13B, gaskets 60C′ and 60D′ used in sealing the sides of the roofing system where the roofing panels 40 engage the structural beams can comprise a different shape from the stepped gaskets shown in FIGS. 5A,11A and 11B. The top roofing panel gasket 60C′ and the bottom roofing panel gasket 60D′ can be the same or similar in shape, length, and thickness and can be described with reference to gasket 60′ shown in side profile in FIG. 13C. The gasket 60′ can comprise a longitudinal base 62′ having a first side 62A′ and a second side 62B′ running the length of the base 62′. An engagement rail 64′ can extend outward from the first side 62A′ of the base 62′. The engagement rail 64′ can be configured to attachably engage a respective gasket attachment channel 34A, 34B, 58A, 58B in either a structural beam 20 or a top cap 50 of a roofing system 10. For example, in some embodiments, the engagement rail 64′ can comprise a rail track 64A′ that can be inserted into a base of a gasket attachment channel 34A, 34B, 58A, 58B and a stem 64B that extends between the longitudinal base 62′ and the rail track 64A′. The rail track 64A′ can be larger in width than at least a lower portion of the stem 64B′ such the rail track 64A′ can slidably fit within a base of a gasket attachment channel 34A, 34B, 58A, 58B while the lower portion of the stem 64B′ can slidably fit between the respective lips 32A, 57A of the gasket channel walls 32, 57 of the respective gasket attachment channels 34A, 34B, 58A, 58B.

Each roofing panel gasket 60′ can also comprise a sealing body 66′ that can extend upward from the second side 62B′ of the longitudinal base 62′. The sealing body 66′ can comprise a flat surface to form a flat gasket as shown FIG. 13B (see top and bottom gaskets 60C′, 60D′). As shown in FIG. 5B, in some embodiments, the sealing body 66′ can comprise vertical sealing layers 68′. The vertical layers 68′ can each have the stepped longitudinal profile of the sealing body 66′. The vertical layers 68′ can create a better and longer lasting seal between roofing panel gasket 60′ and the roofing panels 40′. In some embodiments, the sealing body 66′ may not employ such vertical sealing layers 68′.

The bottom flat gaskets 60D′, for example, as shown in FIG. 13B, can form the bottom seal against the roofing panels such as solar modules 42 and can be slid into the gasket attachment channels 34A, 34B of the top wall 22A of the structural beam 20 similarly to the gaskets being slid into the gasket attachment channels as shown in FIGS. 6A-6C. As stated above, the bottom gaskets 60D′ are positioned along the span of the length of the respective structural beams 20 to received roofing panels 40 such as solar modules 42, for example, by inserting engagement rail 64D′ of the respective bottom flat gaskets 60D′ in the gasket channel of the respective structural beam with the flat sealing body 66D′ extending from the base 62D′ and facing outward to engage the solar modules 42 as shown in FIG. 13B. The top flat gaskets 60C′ can form the top seal against the roofing panels such as solar modules 42. The top caps 50 may also be prepared by inserting engagement rail 64C′ of top gaskets 60C′ into the gasket attachment channels 58A, 58B of the top caps 50 so that the flat sealing body 66D′ extending from the base 62D′ face outward in preparation of attachment of the top caps 50 to the structural beams 20 over the roofing panels, such as solar modules 42. Since the top and bottom gaskets 60C′, 60D′ are flat, the roofing panels such as solar modules 42 can be positioned side-by-side with a panel seal 90, such a T-seal 94, secured between solar modules 42 and overlapping top and portions of the side-by side solar modules 42.

The solar modules 42 that can comprise the roofing panels 40 of a building structure can be positioned on one or more bottom flat gaskets 60D′ as shown in FIG. 13B. The wiring and optimizers and/or microinverters can be attached to the solar modules 42 to permit the solar modules 42 to operate properly once the system is activated as described above. A panel seal 90, such a T-seal 94, can be secured between solar modules 42 and overlapping top and portions of the side-by side solar modules 42. Top caps, as described above with reference to top caps 50, with one or more top flat gaskets 60C′ as shown in FIG. 13B installed thereon can then be placed over the solar modules 42 and secured to the structural beam as described above with the solar modules 42 sandwiched between the top flat gasket 60C′ and the bottom flat gasket 60D′ as shown in FIG. 13B. Fasteners can be used to secure the top caps to the structural beams as described above.

Thus, a simple and easy construction of a roof can be accomplished using the roofing system 10 that is assembled using a limited number of steps. When solar panels are used, the roofing system 10 can also provide an integrated solar rack system to eliminate a separate rack that is attached to the top of the roof structure. The roofing system 10 can be provided in kit form or in a partial prefab form to allow for quick and easy assembly.

Although not the primary anticipated use, a smaller, modified version of the beam can be used for solar module mounting systems for traditional rooftop or ground mount-based systems. In this case the beam is run horizontally and attached to a top of an existing roof using traditional solar mounting brackets, instead of being integrated into a roofing structure. Instead of being integrated into a roofing structure, the rack sits above the existing roof and is bolted in or sits on a traditional ground mount structure. The solar modules are sandwiched between the beam and the top cap without a gasket for framed modules and with a gasket for frameless modules. The design eliminates one rail for each row beyond the first row of modules by supporting the edges of the solar module so a single rail can support two modules where they meet and also incorporates a unique wire management system.

Thus, a plurality of method of making and using the roofing systems and roofing components disclosed herein are provided as described above. For example, an embodiment of a method of forming a roofing system can be provided. The method can comprise providing a plurality of structural beams with each of the structural beams comprising an extruded aluminum structural beam and roofing panels comprising at least one of an insulated roofing panel or a solar module. The method can also comprise providing a plurality of top caps corresponding to the number of the structural beams, the top caps configured to secure the roofing panels in place on the structural beams and providing gaskets for sealing the roofing panels. The method can further comprise securing the plurality of structural beams to a base structure and securing gaskets to the structural beams and to the top caps. The roofing panels can be positioned on the gaskets secured to the structural beams. The top caps can be placed in alignment with respective structural beams such that the gaskets secured to the top caps engage the roofing panels. The method can additionally comprise securing the top caps to the respective structural beams such that the gaskets secured to the structural beams and the gaskets secured to the top caps sealably engage the roofing panels. One or more interior gutters built into each of the structural beams to drain any water that leaks between the gaskets and the roofing panels.

In some embodiments, the method can also comprise attaching end fins to at least one of the structural beams or the top caps to enclose end edges of the roofing system. In some embodiments, the method can also comprise attaching one or more wire troughs to a side of a structural beam of the plurality of structural beams, each of the one or more wire troughs being configured to accommodate wiring for solar modules used as roofing panels.

In some embodiments, the step of securing the top caps can comprise securing a top cap of the one or more top caps to a respective structural beam of the plurality of structural beams via a threaded channel on a top portion of the respective structural beam. In some such embodiments, the threaded channel on the top portion of the respective structural beam can be formed as an integral part of the respective structural beam during the extrusion process. In some such embodiments of the method, the step of securing gaskets to the structural beams comprises sliding bottom gaskets into gasket attachment channels on the respective structural beam. In some such embodiments, the method can further comprise using at least one of the gasket attachment channels for securing an end fin to the respective structural beam. Additionally, in some such embodiments, the method can comprise forming side walls of the one or more interior gutters with channel walls of the thread channel and one or more gasket attachment channels on each of the structural beams. As stated above, the disclosure above teaches other steps that can be included in such methods.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only, and is not intended to limit the present subject matter.

1. A roofing system comprising:
a plurality of structural beams, each of the structural beams comprising an extruded aluminum structural beam;
roofing panels comprising at least one of an insulated roofing panel or a solar module;
a plurality of top caps corresponding to the number of the structural beams, the top caps configured to secure the roofing panels in place on the structural beams;
gaskets for sealing the roofing panels;
end fins attachable to at least one of the structural beams or the top caps to enclose end edges of the roofing system; and
one or more interior gutters built into each of the structural beams to drain any water that leaks between the gaskets and the roofing panels.

2. The roofing system according to claim 1, further comprising one or more wire troughs configured to accommodate wiring for solar modules used as roofing panels, each of the one or more wire troughs being attachable to a side of a structural beam of the plurality of structural beams.

3. The roofing system according to claim 2, wherein each of the structural beams comprises one or more T-bolt slots, the T-bolt slots being usable for attaching a wire trough of the one or more wire troughs and for securing bolts to the respective structural beam for securement of structural attachment brackets for securing the respective structural beam to a building structure being roofed.

4. The roofing system according to claim 3, wherein each of the one or more T-bolt slots in each of the structural beams is formed in the respective structural beam during extrusion of the respective structural beam.

5-6. (canceled)

7. The roofing system according to claim 1, wherein each of the structural beams comprises a threaded channel on a top portion of the respective structural beam for securing a top cap of the plurality of top caps to the respective structural beam and wherein each of the structural beams comprises one or more gasket attachment channels for securing bottom gaskets of the gaskets for forming a seal between the roofing panels to the respective structural beam.

8. The roofing system according to claim 7, wherein each of the one or more gasket attachment channels is usable for securing one of the end fins to the respective structural beam.

9. The roofing system according to claim 7, wherein channel walls of the thread channel and one or more gasket attachment channels on each of the structural beams forms side walls of the one or more interior gutters.

10. The roofing system according to claim 7, wherein each of the one or more gasket attachment channels of the respective structural beam is formed as an integral part of the respective structural beam during the extrusion process.

11. The roofing system according to claim 7, wherein each of the top caps comprises one or more gasket attachment channels for securing top gaskets of the gaskets for forming a seal between the roofing panels and the respective top cap.

12. The roofing system according to claim 11, wherein each of the one or more gasket attachment channels is usable for securing one of the end fins to the respective top cap.

13. The roofing system according to claim 11, wherein each of the top cap is formed by extruded aluminum and each of the one or more gasket attachment channels of the respective top cap is formed as an integral part of the respective top cap during the extrusion process.

14-19. (canceled)

20. The roofing system according to claim 1, wherein the gaskets for sealing the roofing panels are flat gaskets to accommodate side-by-side the roofing panels.

21. (canceled)

22. A structural beam for use in a roofing system, the structural beam comprising:
an extruded beam having a length, the extruded beam comprising a top wall and a bottom wall and two opposing side walls;
one or more T-bolt slots in at least one of the side walls of the extruded beam of receiving accessory attachments;
channel walls extending upward from the top wall of the extruded beam, the channel walls forming a threaded channel for securing a top cap to the extruded beam that extends the length of the extruded beam; and
gasket channel walls extending upward from the top wall of the extruded beam, the gasket channel walls forming one or more gasket attachment channels for securing gaskets to the extruded beam.

23. The structural beam according to claim 22, further comprising a bonding rail extending outward from one of the side walls of the extruded beam above a T-bolt slot with the bonding rail being formed as an integral part of the extruded beam during the extrusion process.

24-26. (canceled)

27. The structural beam according to claim 22, further comprising one or more interior gutters formed along the top wall of the extruded beam, wherein the one or more interior gutters are formed between the channel walls that form the threaded channel extending upward from the top wall and the gasket channel walls forming the one or more gasket attachment channels extending upward from the top wall.

28-32. (canceled)

33. A method of forming a roofing system, the method comprising:
providing a plurality of structural beams, each of the structural beams comprising an extruded aluminum structural beam;
providing roofing panels comprising at least one of an insulated roofing panel or a solar module;
providing a plurality of top caps corresponding to the number of the structural beams, the top caps configured to secure the roofing panels in place on the structural beams;
providing gaskets for sealing the roofing panels;
securing the plurality of structural beams to a base structure;
securing gaskets to the structural beams;
securing gaskets to the top caps;
positioning the roofing panels on the gaskets secured to the structural beams;
placing the top caps in alignment with respective structural beams such that the gaskets secured to the top caps engage the roofing panels;
securing the top caps to the respective structural beams such that the gaskets secured to the structural beams and the gaskets secured to the top caps sealably engage the roofing panels; and
wherein one or more interior gutters built into each of the structural beams to drain any water that leaks between the gaskets and the roofing panels.

34-35. (canceled)

36. The method according to claim 33, wherein the step of securing the top caps to the respective structural beams comprises securing a top cap of the plurality of top caps to a respective structural beam of the plurality of structural beams via a threaded channel on a top portion of the respective structural beam.

37. (canceled)

38. The method according to claim 36, wherein the step of securing gaskets to the structural beams comprises sliding bottom gaskets into gasket attachment channels on the respective structural beam.

39. The method according to claim 38, further comprising using at least one of the gasket attachment channels for securing an end fin to the respective structural beam.

40. The method according to claim 38, further comprising forming side walls of the one or more interior gutters with channel walls of the thread channel and one or more gasket attachment channels on each of the structural beams.
